(19) United States
(12) Patent Application Publication
(10) Pub. No.: US 2002/0090001 A1
(43) Pub. Date: Jul. 11, 2002

(54) Wireless communications hub with protocol conversion

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 10/074,110

(22) Filed: Feb. 11, 2002

Related U.S. Application Data
(63) Continuation-in-part of application No. 09/479,605, filed on Jan. 6, 2000.
(60) Provisional application No. 60/116,984, filed on Jan. 25, 1999.

(51) Int. Cl. H04J 3/16

(52) U.S. Cl. 370/466; 340/870.28; 340/870.14

(57) ABSTRACT

A wireless hub for use in an electric utility substation, said hub providing two-way wireless communications digital information between the hub and associated IEDs. The hub includes a protocol processor, a data processor and a Scada processor. The data processor exchanging two-way digital information with IEDs using protocols of said IEDs. The Scada processor exchanges two-way digital information with an external source having its own protocol, and the protocol processor converts two-way digital information between protocols of said IEDs and the protocol of an external source. The hub includes circuits that permit any one of the three processors to select either of the other two processors to exchange digital information with the chosen processor.

This application is a continuation in part of application Ser. No. 09/479,605 titled “EXPANDED CAPABILITIES FOR WIRELESS TWO-WAY PACKET COMMUNICATIONS FOR IEDs” filed by Robert W. Beckwith on Jan. 08, 2000 which claimed the priority date of provisional patent application Ser. No. 60/116,984 filed by Robert W. Beckwith on Jan. 25, 1999. Note that the title been change.

### PRIOR ART

Reference numbered 3, cited below, describes a hub manufactured by Schweitzer Engineering Co. This reference is typical of hubs available for use over land lines. As far as is known to the present inventor, no wireless hub with protocol conversion is available.

### REFERENCES

1. U.S. Pat. No. 5,943,202 for TWO WAY PACKET RADIO INCLUDING SMART DATA BUFFER AND PACKET RATE CONVERSION issued on Aug. 24, 1999 to Robert W. Beckwith, the inventor herein.

2. A product release titled “Prism II, 11 MBPS” referring to a commercial chip product supplied by the Intersil Corporation (3 pages).

3. “SEL-2030 Communications Processor” manual by Schweitzer Engineering Laboratories, Inc. Pullman, Wash., USA, date code 20010619 (16 pages).

### BACKGROUND

This invention relates to detailed structure for an electric utility substation hub using radio communication and is related to U.S. Pat. No. 5,943,202, referenced above. A patent application Ser. No. 08/421,378 relating to radio communication for substations was filed on Apr. 13, 1995; application Ser. No. 08/421,378 was abandoned after a related patent application Ser. No. 08/710,816 was filed on Sep. 23, 1996. Patent application Ser. No. 08/710,816 matured into the afore noted U.S. Pat. No. 5,943,202.

A hub type operation for utility substations may have separate levels of application wherein at a level one, the equipment receives current, voltage and other primary sensor inputs and sends control commands to circuit breakers, tapchanger, etc. Level one equipment sends raw data upward and receives digital signals back by means of radial two-way fiber optic cables between a hub and control devices. Various types of microprocessors may be used in such hub system.

A level two of the hub operation may consists of one or more computers at each substation and generating plant. Each computer is connected to a hub and has the task of receiving information, refined from raw data by the hub and extracting further refined information required by upper levels. Information is also passed between level one devices by the hub, as required. Upper level communications protocol tasks will be provided by computers, thereby freeing level one devices to preform their basic functions rapidly and accurately.

U.S. Pat. No. 5,943,202 discloses a substation hub with a radio communicating with IEDs (Intelligent Electronic Device's). Each IED communicates to the hub (communicating center) via a radio. The present invention is an improvement on this earlier invention disclosed in Pat. No. 5,943,202 and also adds architectural structure and details for implementing the hub. The term “wireless” is used herein as having substantially the same meaning as the term “radio” used in U.S. Pat. No. 5,943,202.

The term “protocol” will be used herein to include both the methods of data communications and also the list of data points and other device specific information. This list not only changes between suppliers of IEDs but with changes each supplier makes over the course of time and the requirements of the user when placing an order for equipment. Some details of the information may also consist of user set points subject to change by the user. The term “information” is used herein to indicate the combination of actual data and other required information.

The term “SCADA” ( Supervisory Control And Data Acquisition) is in standard use in the electric utility industry and refers to a form of remote control of remotely located (distant) units by electrical means over one or more common interconnecting channels, and it is so used herein.

### SUMMARY OF THE INVENTION

A hub, such as for electric utility substations, uses wireless transceivers to communicate with IEDs. The wireless transceivers implement peer to peer communications provisions, and the invention utilizes the inherent capability of Prism II wireless chips to avoid data crashes and other modes of failure of two-way digital wireless communications.

A “P” (protocol) communications processor in the hub exchanges two-way digital messages with the IEDs, strips information from the messages and passes the information to a “D” (data) processor. The D processor instructs the P processor so as to permit exchange of information with the substation IEDs in spite of protocol differences amongst the IEDs. The D processor stores information exchanged with IEDs in generic form. This information in generic form is exchanged with an “S” (SCADA) processor after being converted to a single protocol form chosen and installed for the SCADA selected for a particular application of the hub. The net result is as if the SCADA were communicating directly with IEDs, and with all IED protocols converted to the one chosen for SCADA. Thus the hub serves as a protocol converter between SCADA and IEDs with which it communicates. The S processor compresses packets of data and transmits and receives them at rates up to 100 megabits per second as compatible with glass fiber optic cable. The hub thus provides a hardware platform which is invariant with the protocol information stored for any particular application.

The foregoing features and advantages of the present invention will be apparent from the following more particular description of the invention. The accompanying drawings, listed herein below, are useful in explaining the invention.

### BRIEF DESCRIPTION OF THE DRAWINGS

FIG. 1 depicts the concept of providing radio (wireless) communication between a substation hub and various IEDs;

FIG. 2 shows a block diagram of the wireless communications hub communicating with an IED;

FIG. 3A shows a rack mounted assembly of six IEDs and a hub;

FIG. 3B shows a laptop computer with a standard type wireless PCMCIA card inserted in the computer slot;

FIG. 3C shows the wireless PCMCIA card;

FIG. 4 shows a pole mounted hub with a directional parabolic antenna located outside the fence of a distribution station and feeding a telephone line;

FIG. 5 shows a pole mounted hub in a case with a directional parabolic antenna located outside the fence of a distribution station and feeding a wireless connection to a remote location; and

FIG. 6 is a schematic diagram of a hub in a case with a directional antenna directed for communications with regulator controls in a distribution substation.

### DETAILED DESCRIPTION OF THE PREFERRED EMBODIMENTS

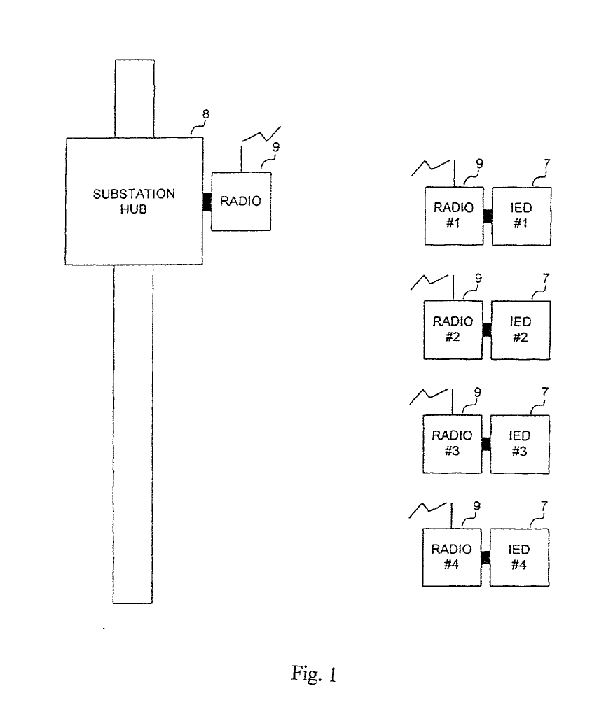

FIG. 1, depicts the broad concept of providing a radio transceiver in a substation hub to communicate with separate radios transceivers of respective IEDs, as disclosed in referenced U.S. Pat. No. 5,943,202, issued to the present inventor.

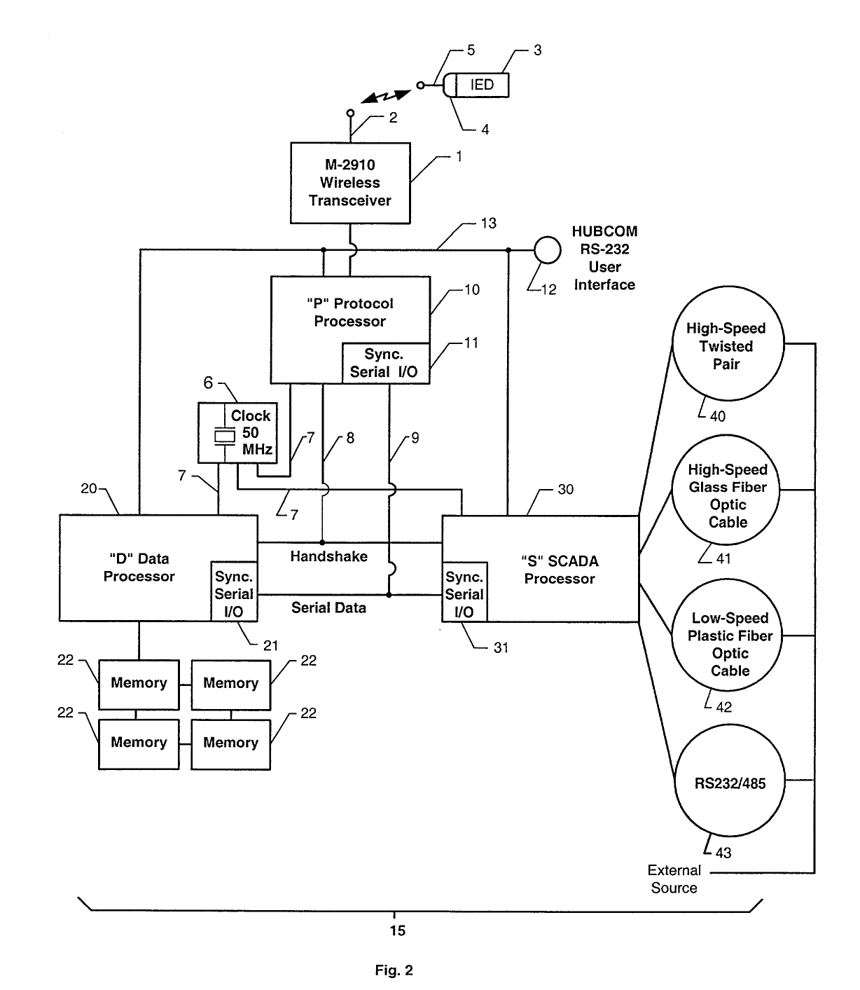

FIG. 2 shows a block diagram of the hub 15 of the present invention. The hub 15 of the uses wireless (radio) transceivers 1, to communicate with IEDs. U.S. patent application Ser. No. 09/997,102 filed on Nov. 20, 2001 for WIRELESS TRANSCEIVERS USING A SIMPLIFIED PRISM II SYSTEM also by Robert W. Beckwith discloses the use of wireless transceivers; said application is incorporated herein by reference as to the description of the use of the wireless transceivers.

Preferably the type of transceivers used are model M-2910 wireless transceivers manufactured by the Beckwith Electric Co. Inc. Note that other commercially available transceivers might be used. The M-2910 transceiver uses an 8 bit code to communicate with up to 255 IEDs so as to provide wireless connection between the hub 15 and a desired IED, the connection is transparent to the protocol of the IED.

In the wireless transceivers 1, the bursts of digital data that are transmitted are completely transparent to any communications between the hub and an IED regardless of protocol used. The wireless transceivers 1 utilize only the peer to peer provisions of IEEE Standard 802.11. Also, instead of using the complete methods described in said IEEE Standard 802.11 to avoid data crashes, the wireless transceivers 1 depend on the inherent capability of Prism II wireless chips to avoid data crashes, and other modes of failure of two-way digital wireless communications. With IED addressing information added, two-way digital data is exchanged by wireless transceivers 1 in a manner which is transparent to the protocol selected by the hub for communicating with any particular IED 3.

Wireless transceiver 1 with antenna 2 is shown communicating with a typical IED 3 via a wireless transceiver adaptor 4. Adaptor 4 and its antenna 5 are connected to IED 3. Typically wireless transceiver adapter 4 is a Beckwith Electric M-2911 Wireless transceiver Module for connecting via communication RS232 ports, 422 ports or 485 ports that connect to IEDs 3; the M-2911 Module thus accommodates to the particular port provided for a given IED. The M-2911 Module also follows inventive principles disclosed in U.S. patent application Ser. No. 09/997,102 referenced above. Other known adaptor modules may be used.

IEDs, not shown, are also available from Beckwith Electric Co. Inc. and other sources, that include a self contained M-2910 transceivers having an antenna 2 for communicating with the M-2910 wireless transceiver 1 that serves the hub 15.

As depicted in FIG. 2, the “D” Data processor has memory generally labeled as 22 which holds protocol information and device related information for all IEDs served by the hub. Memory 22 is preferably a flash memory or other non volatile memory and is typically arranged in banks, four of which are shown in FIG. 1. IED specific information for every IED 3 served by the hub 15 is stored in memory 22 as required for any specific use of the hub 15.

When the “P” Protocol processor 10 is to communicate with an IED 3, it first requests the information for the IED from the D processor 20. This information is used by the P processor to strip header and footer bits so as to extract data from the each message received from IEDs 3 and to add them to messages sent to the IEDs. D Processor 20 converts data exchanged with the P processor 10 to generic form in memory 22 using registers identified for each IED.

The memory of “S” SCADA processor 30 holds protocols required by any particular application of the hub 15. These may be added to the hub 15 as required using a HUBCOM RS-232 user interface, other available interface, temporarily connected to user interface port 12. Alternatively, a selection of protocols may be stored in the S processor memory and activated via HUBCOM for a particular application of the hub 15. A list of protocols may include the following:

a. ASCI

b. Cooper 2179

c. BECO 2179

d. BECO 2200

e. PG&E 2179

f. IEC 870.5

g. UCA 2.0

h. DNP 3.0

i. MODBUS/MODBUS Plus

j. Swedish ISO 61850

While the operating programs for the three processors are written so as to work together properly, each performs its processing independently of the other two. The HUBCOM connection to user port 12 is only used in configuring the hub 15 and is not connected during normal operation of the hub 15.

As indicated above, the hub 15 contains three processors, a P processor 10, a D processor 20, and an S processor 30. Preferably these are Intel 386 processors available for wide industrial grade temperature ranges. The three processors are driven by a single clock 6 over line connections 7, typically operating at 50 MHz. This facilitates transfer of data at high speeds directly between the three microprocessors using bus synchronous serial data ports.

A binary handshake level, blocking or non-blocking, is connected by line connection 8 to binary ports on the three processors. The handshake level is set to the blocking level at the bit time instant that a processor transmits a message. The handshake prevents the microprocessor to which the message is not addressed from initiating a message. Only the processor that initiated the communications can change the handshake level to the non-blocking state and does so when the data exchange is complete.

Line 9 represents a network which connects synchronous serial input/output port 11 of processor 10, port 21 of processor 20 and port 31 of processor 30. The network represented by line 9 provides the necessary buffering and output to input steering to provide two-way information exchanges between any to processors at the highest synchronous rates available from the processors. Data crashes between the microprocessors is thus prevented while at the same time allowing each processor to initiate communications with either of the other two.

A selection of input/output communication ports are provided. Typically these include high speed ports 40 for pairs of copper wire, 100 megabit per second ports 41 for glass fiber optic cables, low speed ports 42 for plastic fiber optic cables and RS232/RS485 ports 43. Whichever output port is selected provides communications from the hub 15 to an external source.

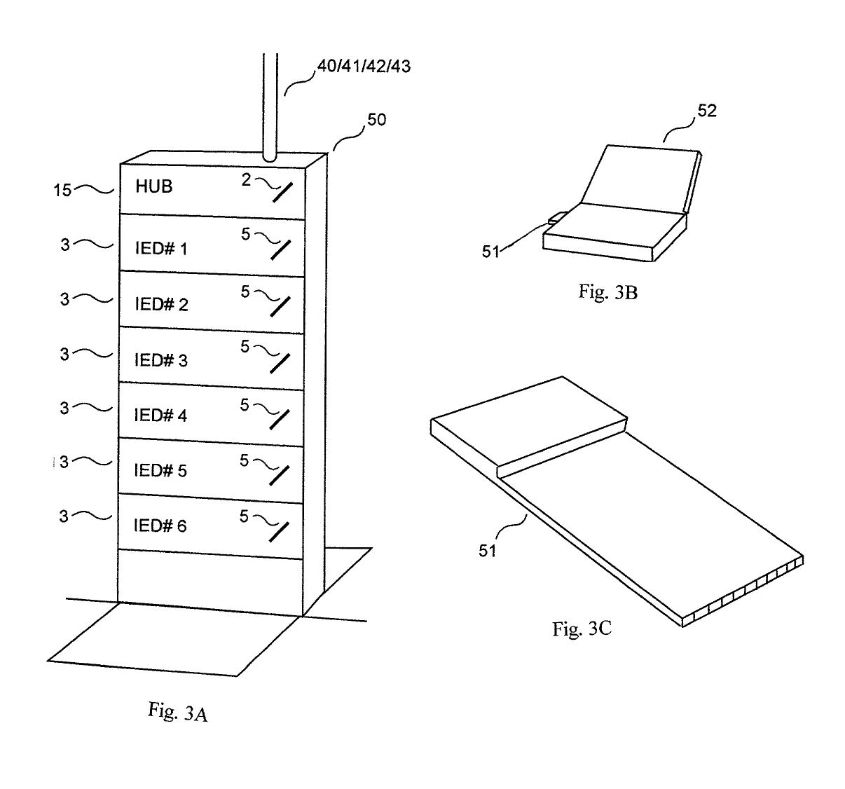

FIG. 3A shows a hub 15 that is rack mounted with six IEDs 3 in a typical free standing rack 50. Hub 15 output selects the desired one of output ports 40, 41, 42, or 43 indicated by the notation “40/41/42/43”. Refer also to FIG. 2, that more clearly indicates the selective connection of the output ports 40-43 to the external source.

FIG. 3B shows laptop computer 52 equipped as a user interface by insertion of a Beckwith Electric Co. Model M-2912 Wireless-to-PCMCIA Module 51; this module follows the inventive principles of U.S. patent application Ser. No. 09/997,102 referenced above.

FIG. 3C shows the M-2912 Module which is inserted into standard computer slot of FIG. 3B. Two-way digital information is exchanged between user interface computers 52 and hub 15 using the internal antenna, not shown, of module 51.

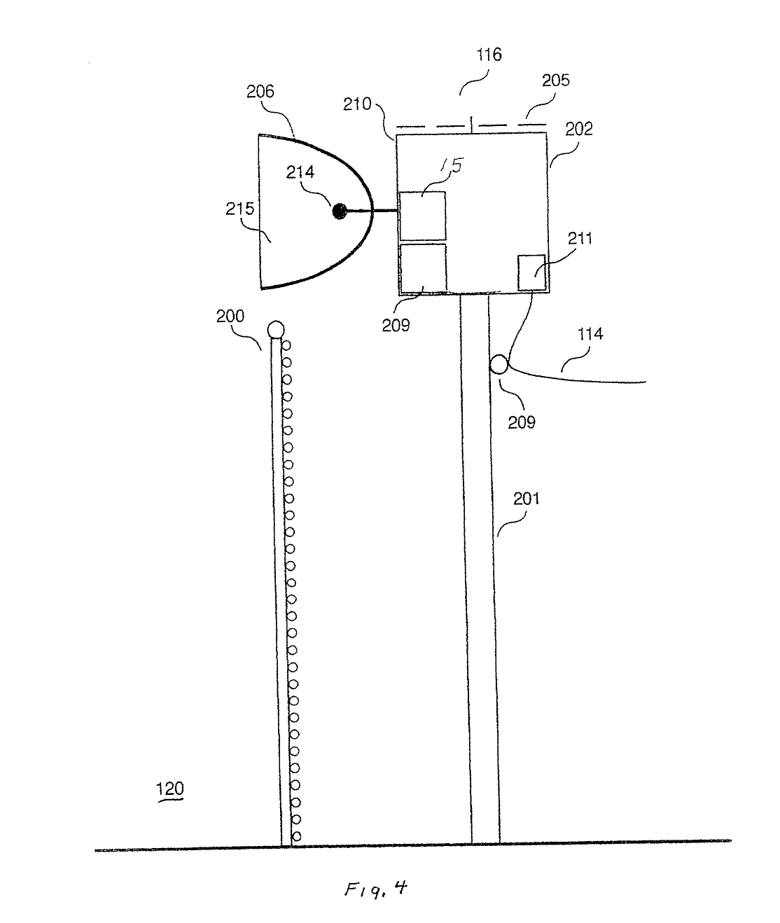

FIG. 4 shows a wireless communications assembly 116 consisting of hub 15 and auxiliary devices contained in enclosure 202 on pole 201 outside fence 200 surrounding substation 120. The hub 15 drives antenna 214 contained in parabolic reflector 206 with endplates 215. Antenna reflectors 206 are parabolic in shape in the vertical dimension and straight lines in the horizontal dimension. Antennas 214 are horizontal conductors, an even number of half waves of the wireless communications frequency long. Reflector end plates 215 connect to ends of antennas 214. Parabolic antenna reflectors 206 are mounted on face 210 of enclosure 202 and pointed towards substation 120 so as to communicate with IEDs 3 located within substation 120. This provides high gain directed communications to IEDs within substation 120 while at the same time shielding antenna 214 from interference outside of the substation in the direction away from substation 120. Wireless communications signals are supplied to antennas 214 by wireless communications transceivers 1. Power for hub 15 is furnished by gel cells 209 in turn charged by solar cells 205.

Telephone line 114 is tied to pole 201 by screw eye 209 before entering enclosure 202 and connecting to telephone modem 211 for exchange of information between hub 15 and outside users of the information. Selectively wired telephone lines 114 may be replaced by fiber-optic cable lines.

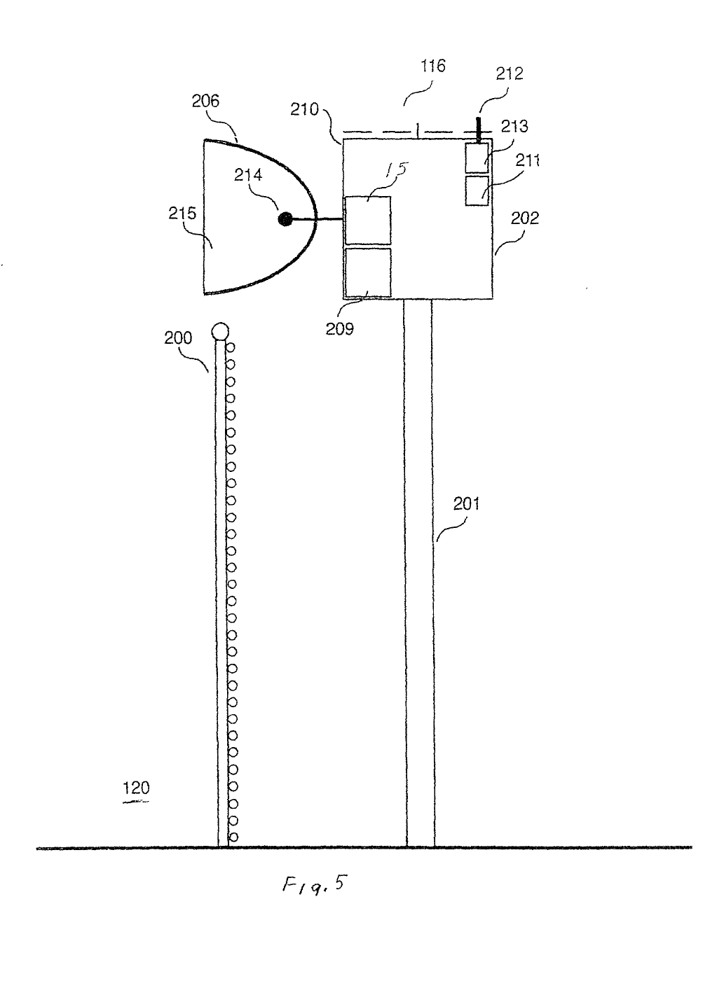

FIG. 5 shows another embodiment of a wireless communications assembly 116 consisting of a hub 15 contained in enclosure 202 on pole 201 outside fence 200 surrounding substation 120, and is similar to the embodiment of FIG. 4. The hub 15 drives antenna 214 contained in parabolic reflector 206 with end-plates 215. Antenna reflectors 206 are parabolic in shape in the vertical dimension and straight lines in the horizontal dimension. Antennas 214 are horizontal conductors an even number of half waves of the wireless communications frequency long. Reflector end plates 215 connect to ends of antennas 214. Parabolic antenna reflectors 206 are mounted on face 210 of enclosure 202 and pointed towards substation 120 so as to communicate with IEDs 3 located within substation 120. This provides high gain directed communications to IEDs within substation 120 while at the same time shielding antenna 214 from interference outside of the substation in the direction away from substation 120. Wireless communications signals are supplied to antennas 214 by wireless communications transceivers 1. Wireless telephones 213 with modems 211 use antennas 212 for exchange of information between hub 15 and outside users of the information. Power for hub 15, wireless phones 213 and modems 211 is furnished by standard gel cells 209, in turn charged by standard solar cells 205.

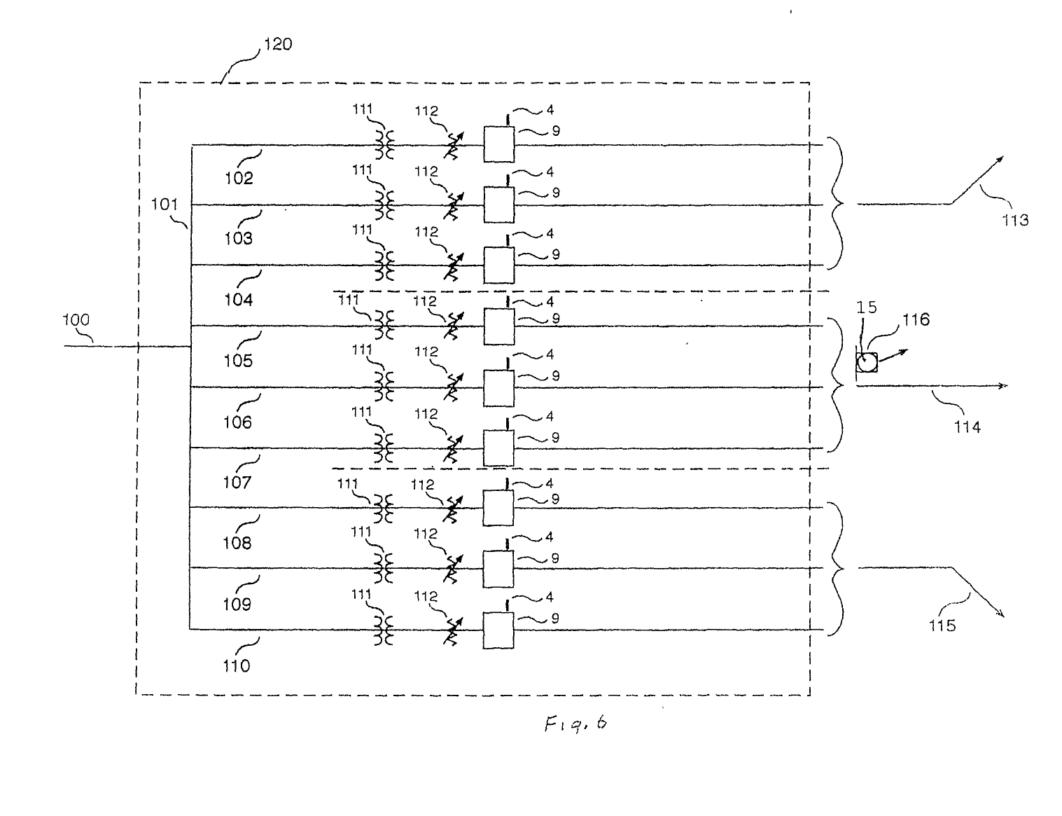

FIG. 6 is a view looking down on a substation 120 that uses regulators 112 to feed three outgoing power distribution lines 113, 114, and 115. Power to distribution substation 120 is provided by incoming subtransmission lines 100 to bus 101, both lines and bus shown in single line form for the three wires of three phase circuits and bus. Three phase lines 102, 103 and 104 are transformed down in voltage to distribution level by three transformers 111 through the three regulators 112 controlled by regulator controls 9 (one typical type of IED) to provide power to substation output distribution lines 113. In an similar way three phase lines 105, 106 and 107 supply distribution lines 114 and lines 108, 109 and 110 supply distribution lines 115. A wireless communications assembly 116 including a hub 15 exchanges two-way digital information with the nine regulators 9 in substation 120. A total of nine wireless regulator communications antennae 4, each combined with one of the total of nine regulator controls 9 complete the exchange of information with hub 15.

The overall result of the system illustrated by FIG. 6 is to allow an outside source to communicate with IEDs 9 in substation 120, using a protocol selected and established in hub 15 by the outside source, regardless of the variation of protocols amongst the IEDs 9.

### Advantages of the Invention

A. The hub eliminates the costs of communications cabling, wiring and record keeping.

B. Takes the cost of protocol handling out of IEDs and places a single cost in the hub.

C. Allows the use of simple protocols in substation IEDs.

D. Allows peer to peer communications amongst IEDs.

E. Easily added to existing substations.

F. Provides easy updating of protocol programs as standards change.

G. Provides access to IED data not restricted by protocol standardization.

While the invention has been particularly shown and described with reference to preferred embodiments thereof, it will be understood by those skilled in the art that various changes in form and details may be made therein without departing from the spirit and scope of the invention.

I claim:

1. Apparatus for wireless communications of two-way digital information between a hub and IEDs comprising in combination:
a) a first processor which exchanges two-way digital information with IEDs using protocols of said IEDs;
b) a second processor which exchanges two-way digital information with an external source having its own protocol;
c) a third processor which converts two-way digital information between protocols of said IEDs and the protocol of an external source; and
d) communications circuits which permit any one of said three processors to select either of the other two processors and exchange digital information with the processor so chosen.

2. Apparatus as in claim 1 further comprising devices which provide two-way wireless digital communications between said hub and said IEDs and which are transparent to communications protocols.

3. Apparatus as in claim 1 further comprising circuits providing two-way digital communications between any one of said three processors and either of the other two of said processors.

4. Apparatus as in claim 1 further comprising a frequency determining device to provide a single clock for all of said three processors.

5. Apparatus as in claim 1 further comprising circuits that provide for exchange of synchronous serial information between any two of said three processors.

6. Apparatus as in claim 5 further comprising circuits that provide for blocking transmission from one of said three processors whenever the other two are communicating.

7. Apparatus as in claim 1 further comprising in combination:
a) synchronous serial data transmitting and receiving ports for each of the three processors;
b) common communications paths between said synchronous serial data transmitting and receiving ports of said three processors;
c) two-way binary outputs from each of said three processors;
d) a common connection between said two-way binary outputs of said three processors;
e) program means for a first of said three processors to select one of the other two processors to receive data;
f) program means for said first of said processors to bring said common connection between binary outputs to a level which blocks data transmissions from by a second of three processors that was not selected to receive data; and
g) program means for said first processor to release said common connection between binary outputs when the data exchange is complete.

8. Apparatus as in claim 1 further comprising banks of memory in said second processor having files identified with each of said IEDs so as to convert said data from the form of the IED to generic form or from generic form to form of the identified IED as required dependent on direction of flow of messages.

9. Apparatus as in claim 8 further comprising in combination:
a) a configuration port for said hub for initiating and updating said files identified with each of said IEDs; and
b) programs for computers usable for entering said initiating and updating information through said configuration port.

10. Apparatus as in claim 1 further comprising in combination:
a) a configuration port for said hub;
b) program means in each of said three processors to selectively accept communications obtained through said configuration port;

11. Apparatus as in claim 2 further comprising in combination:
a) inner enclosures for said first, second and third processors;
b) battery means for powering said processors;
c) solar cells for charging said battery means;
d) a directional antenna for said two-way wireless digital communications device;
e) an outer enclosure for mechanically combining said inner enclosure, said battery, said solar cell and said directional antenna; and
f) pole or other mounting structure for supporting said outer enclosure.

12. A method for wirelessly communicating two-way digital information between a hub and IEDs the method comprising in combination:
a) communicating between said hub and said IEDs using protocols of each said IED;
b) communicating two-way digital information between said hub and an external source having its own protocol; and
c) converting two-way digital information between said IED protocols and said protocol of an external source.

13. A method as in claim 12 further including the steps of:
a) communicating with said IEDs using a first microprocessor;
b) communicating with said external source using a second processor;
c) converting between protocols for said IEDs and protocols for said external source using a third processor; and
d) enabling any one of said three processors to select one of the other two processors to exchange digital information with the processor so chosen.

14. A method as in claim 12 further including the step of using devices which provide two-way wireless digital communications between said hub and said IEDs which are transparent to communications protocols.

15. A method as in claim 12 further including the step of providing two-way digital communications between any one of said three processors and either of the other two of said processors.

16. A method as in claim 13 further including the step of operating said three microprocessors at the same clock frequency.

17. A method as in claim 16 further including the step of using synchronous serial communications between any two of said three microprocessors.

18. A method as in claim 17 further including the step of blocking transmissions from one of said three microprocessors when the other two are communicating.

19. A method as in claim 12 further including the step of:
a) storing information identified with each of said IEDs so as to convert digital information from the form of the IED to generic form or from generic form to form of the identified IED as required dependent on direction of flow of messages; and
b) converting generic digital information to the form required by the protocol of an external source.

20. A method as in claim 19 further including the steps of:
a) providing a configuration port for said hub;
b) programming each of said three processors to selectively accept communications obtained through said configuration port,

21. A method as in claim 20 further including the steps of:
a) using said configuration port for initiating and updating said files identified with each of said IEDs, and
b) using said configuration port for initiating and updating information for converting generic digital information to the form required by the protocol of an external source.

22. A method as in claim 21 further including the step of providing programs for computers usable for entering said initiating and updating information through said configuration port.
